(19) United States
(12) Patent Application Publication
(10) Pub. No.: US 2004/0080495 A1
(43) Pub. Date: Apr. 29, 2004

(54) Optical image detectors and navigation devices employing the same

(76) Inventor: Wan Gyo Jeong, Sungnam-city (KR)

Correspondence Address: CANTOR COLBURN LLP, 55 Griffin Road South, Bloomfield, CT, 06002, US

(21) Appl. No.: 10/691,271

(22) Filed: Oct. 21, 2003

(30) Foreign Application Priority Data
Oct. 23, 2002 (KR) 2002-64988

(51) Int. Cl. G09G 5/08

(52) U.S. Cl. 345/166

(57) ABSTRACT

Optical image detectors and navigation devices employing the same are provided. The optical image detector illuminates incident lights on a surface of an object to generate an image for surface morphology of the object. The optical image detector includes a light source and an incident light generator that receives lights of the light source to generate incident lights. The incident lights include at least two groups of incident lights having different incident angles with respect to the surface of the object. The navigation device employs the optical image detector. The navigation device includes a case having a lower panel. The lower panel has an opening. The optical image detector is installed in the case. The incident light generator receives lights of the light source to generate the incident lights. The incident lights are illuminated on the surface of the object through the opening.

### CROSS-REFERENCE TO RELATED APPLICATION

This application claims the benefit of Korean Patent Application No. 2002-64988, filed Oct. 23, 2002, the disclosure of which is hereby incorporated herein by reference in its entirety.

### BACKGROUND OF THE INVENTION

1. Field of the Invention

The present invention is related to optical image detectors and navigation devices employing the same.

2. Description of the Related Art

An optical mouse for moving a position of a cursor viewed on a digital scanner or a display unit employs an optical detector that recognizes a contrast of an object. In particular, the optical mouse has a light emitting device for illuminating lights such as infrared or visual spectrum rays on a surface of a worktable on which the optical mouse is placed.

An optical mouse having an optimized illumination condition is described in U.S. Pat. No. 5,686,720 to Tullis, entitled “Method and Device for Achieving High Contrast Surface Illumination”. The optical mouse disclosed in the U.S. Pat. No. 5,686,720 is characterized in that a light having an incident angle smaller than 16° is irradiated onto a surface of a medium (e.g., a worktable) having an irregular surface morphology. The incident angle means an angle between an incident ray and the surface of the medium.

FIG. 1 is a schematic cross-sectional view illustrating some disadvantages of an optical detector employed in a conventional optical mouse.

Referring to FIG. 1, incident lights 7 generated from a light emitting device (not shown) are illuminated on a surface of a worktable 5. The light emitting device is disposed in a case of an optical mouse that moves on the worktable 5, and the incident lights 7 are illuminated on the surface of the worktable 5 through an opening formed in a predetermined area of a lower panel of the case.

The worktable 5 is composed of a horizontal panel 1. A surface of the horizontal panel 1 has fine protrusions such as first to fourth protrusions, 3a, 3b, 3c and 3d. In general, heights of the protrusions 3a, 3b, 3c and 3d are different from each other, and distances between the protrusions are also not uniform. For example, as shown in FIG. 1, the second protrusion 3b and the third protrusion 3c may be placed between the first protrusion 3a and the fourth protrusion 3d, and the second protrusion 3b and the third protrusion 3c may be lower than the first protrusion 3a. In this case, when the incident lights 7 with an incident angle a smaller than 16° are illuminated on the surface of the worktable 5, first and second shadow regions 9a and 9b are respectively formed due to the first and fourth protrusions 3a and 3d. Therefore, the incident lights 7 may not illuminate the second and third protrusions 3b and 3c.

In the meantime, an optical sensor 13 is placed on the worktable 5. The optical sensor 13 is installed in the case of the optical mouse. The optical sensor 13 detects lights 11 reflected from the surface of the worktable 5 to generate a two-dimensional image that corresponds to the surface morphology of the worktable 5. The optical sensor 13 comprises a plurality of pixels two-dimensionally arrayed, and each of the pixels generates photocurrent that corresponds to brightness of each area in the image. Therefore, if an area of the first shadow region 9a is larger than that of the respective pixels, the pixels corresponding to the first shadow region 9a may output an identical photocurrent. That is, images corresponding to the second and third protrusions 3b and 3c are not generated. Thus, it is difficult to obtain a high resolution of an image on the surface morphology of the worktable 5. This may cause a performance degradation of the optical mouse. That is, even though the optical mouse moves on the worktable, a cursor indicating a current position of the optical mouse may not be moved on a display unit.

According to the conventional optical mouse, it is difficult to obtain a high resolution image of the surface morphology of the worktable since the incident lights have small incident angle. Hence, the optical mouse may malfunction.

### SUMMARY OF THE INVENTION

It is a feature of the present invention to provide optical image detectors that are suitable to improve a resolution of an image for surface morphology of an object.

It is another feature of the present invention to provide optical mice that can generate an accurate position signal employing a high-performance optical image detector.

It is still another feature of the present invention to provide navigation devices that can recognize an accurate pattern of an object employing a high-performance optical image detector.

According to an aspect of the present invention, there is provided an optical image detector that illuminates incident lights on a surface of an object to generate an image for the surface morphology of the object. The optical image detector comprises a light source and an incident light generator for producing incident lights in response to lights from the light source. The incident lights contain at least two groups of incident lights having different incident angles to the surface of the object.

According to an embodiment of the present invention, the incident light generator may comprise a first reflecting plate that reflects lights from the light source to generate a first group of incident lights having a first incident angle with respect to the surface of the object, a second reflecting plate that reflects lights from the light source to generate a second group of incident lights having a second incident angle smaller than the first incident angle, and a third reflecting plate that reflects lights from the light source to generate a third group of incident lights having a third incident angle smaller than the second incident angle.

Also, the present invention may further comprise an optical sensor that is placed over the surface of the object to detect lights reflected from the surface of the object. The optical sensor has a function that converts the image of the surface morphology of the object to a photocurrent.

According to another aspect of the present invention, navigation devices are provided. The navigation devices may correspond to an optical mouse moved on a surface of an object or a pattern recognizer that can recognize a human fingerprint. The navigation device employs a high-performance optical image detector. The navigation device comprises a case having a lower panel. The lower panel has an opening that penetrates a predetermined region of the lower panel. A light source is placed in the case and an incident light generator is disposed to be adjacent to the light source. The incident light generator converts the lights from the light source into at least two groups of incident lights that have different incident angles with respect to the surface of the object. The incident lights from the incident light generator are illuminated on the surface of the object through the opening.

According to the present invention, at least two groups of incident lights having different incident angles are illuminated on the surface of the object. Accordingly, it can improve an image resolution for the surface morphology of the object such as a worktable or a human finger.

### BRIEF DESCRIPTION OF THE DRAWINGS

The above and other features and advantages of the present invention will become more apparent to those of ordinary skill in the art by describing in detail preferred embodiments thereof with reference to the attached drawings in which:

FIG. 1 is a schematic cross-sectional view for illustrating an operational principle of a conventional optical image detector;

FIG. 2 is a schematic cross-sectional view for illustrating an operational principle of an optical image detector according to the present invention;

FIG. 3 is a schematic cross-sectional view illustrating an optical image detector according to an embodiment of the present invention;

FIG. 4 is a schematic view of a digital scanner employing an optical image detector according to the present invention; and

FIG. 5 is a schematic cross-sectional view of an optical mouse employing an optical image detector according to the present invention.

### DETAILED DESCRIPTION OF THE INVENTION

The present invention will now be described more fully hereinafter with reference to the accompanying drawings, in which preferred embodiments of the invention are shown. This invention may, however, be embodied in different forms and should not be construed as limited to the embodiments set fourth herein. Rather, these embodiments are provided so that this disclosure will be thorough and complete, and will fully convey the scope of the invention to those skilled in the art. In the drawings, the thickness of layers and regions are exaggerated for clarity. Like numbers refer to like elements throughout the specification.

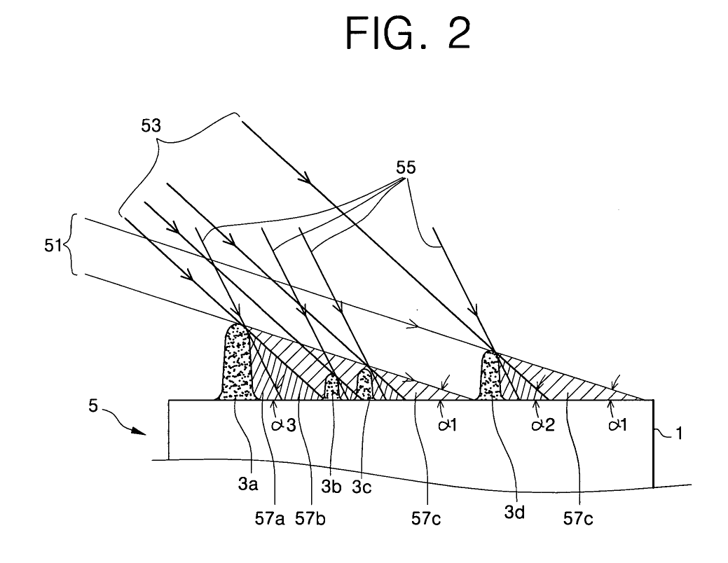

FIG. 2 is a schematic sectional view for illustrating an operation of an optical image detector according to an embodiment of the present invention.

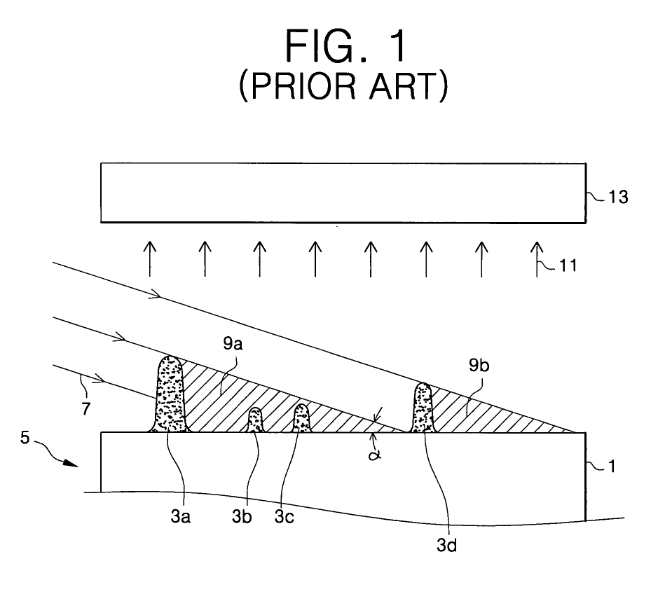

Referring to FIG. 2, incident lights are illuminated on a surface of an object 5 such as the worktable shown in FIG. 1. The object 5 comprises a plurality of fine protrusions 3a, 3b, 3c and 3d formed irregularly on the surface thereof, as described in the FIG. 1. The incident lights include at least two groups of incident lights having different incident angles in contrast with the conventional art. For example, the incident lights may include first to third groups of incident lights 51, 53 and 55, as shown in FIG. 2. The first group of incident lights 51 are irradiated on the object 5 to have a first incident angle α1 with respect to a horizontal surface of the object 5, and the second group of incident lights 53 are irradiated on the object 5 to have a second incident angle α2 larger than the first incident angle α1. Also, the third group of incident lights 55 are irradiated on the object 5 to have a third incident angle α3 larger than the second incident angle α2. Thus, shadows of the second and third protrusions 3b and 3c as well as shadows of the first and fourth protrusions 3a and 3d placed between the first and fourth protrusions 3a and 3d can be clearly formed due to the first to third groups of incident lights 51, 53 and 55. Here, the incident angles are within the range of 0° to 90°.

Furthermore, the first to third groups of incident lights 51, 53 and 55 are combined to form other shadows that correspond to each height of the protrusions 3a, 3b, 3c and 3d, and each space among the protrusions 3a, 3b, 3c and 3d. For example, in contrast with the conventional art, the shadows of the second and third protrusions 3b and 3c as well as the shadow of the first protrusion 3a can be clearly formed in a region between the first protrusion 3a and the fourth protrusion 3d. In more detail, first shadow regions 57a where any incident lights 51, 53 or 55 are not illuminated are formed at one side of the respective protrusions 3a, 3b, 3c and 3d, and second shadow regions 57b where only the third group of the incident lights 55 are illuminated are formed to be adjacent to the first shadow regions 57a. In addition, a third shadow region 57c where a combination light of the second and third groups of the incident lights 53 and 55 is illuminated are formed in the region adjacent to the second shadow region 57b. Accordingly, final shadow regions corresponding to each height of the protrusions 3a, 3b, 3c and 3c and each space between the protrusions 3a, 3b, 3c and 3d are formed by the combination of the shadow regions 57a, 57b and 57c.

Consequently, an image close to the actual surface morphology of the object 5 can be generated because the final shadow regions can be classified into more divided grades as compared to the conventional art.

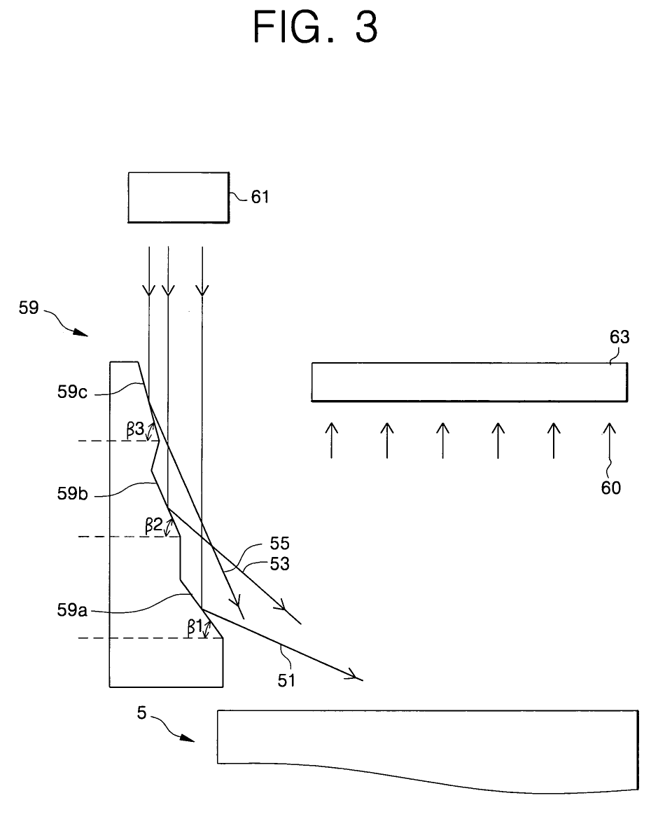

FIG. 3 is a schematic cross-sectional view illustrating an optical image detector according to an embodiment of the present invention.

Referring to FIG. 3, an incident light generator 59 is placed above one side of the object 5. The object 5 may correspond to a worktable or a human finger. The incident light generator 59 produces the first to third incident lights, 51, 53 and 55 shown in FIG. 2. A light source 61 is installed over the incident light generator 59. The light source 61 emits lights such as infrared or visual spectrum rays, and the lights from the light source 61 are illuminated on the incident light generator 59.

The incident light generator 59 comprises a plurality of reflecting plates. For example, the incident light generator 59 may include a first reflecting plate 59a, a second reflecting plate 59b and a third reflecting plate 59c that reflect the lights from the light source 61. The first reflecting plate 59a corresponds to a sloped surface having a first angle β1 with respect to a horizontal surface of the object 5, the second reflecting plate 59b corresponds to a sloped surface having a second angle β2 greater than the first angle β1, and the third reflecting plate 59c corresponds to a sloped surface having a third angle β3 greater than the second angle β2. In this case, it is preferable that the second reflecting plate 59b is disposed at a lower level than the third reflecting plate 59c and the first reflecting plate 59a is disposed at a lower level than the second reflecting plate 59b. This is for illuminating all lights reflected from the surfaces of the reflecting plates onto a predetermined area of the object 5. Also, it is preferable that the first reflecting plate 59a is relatively more protruded than the second reflecting plate 59b and the second reflecting plate 59b is relatively more protruded than the third reflecting plate 59c. Thus, the lights downwardly emitted from the light source 61 are uniformly illuminated on the first to third reflecting plates 59a 59b, and 59c, and the incident lights reflected from the reflecting plates 59a, 59b and 59c can be divided into the first to third groups of incident lights 51, 53 and 55 described in FIG. 2.

An optical sensor is placed over the object 5. The optical sensor is composed of a plurality of pixels, which are two dimensionally arrayed. Each of the pixels generates a photocurrent or a photo-voltage that corresponds to brightness of the light reflected from the surface of the object 5. As a result, the resolution of the optical image for the surface morphology of the object 5 can be improved as compared to the conventional art, since at least two groups of incident lights having different incident angles are employed.

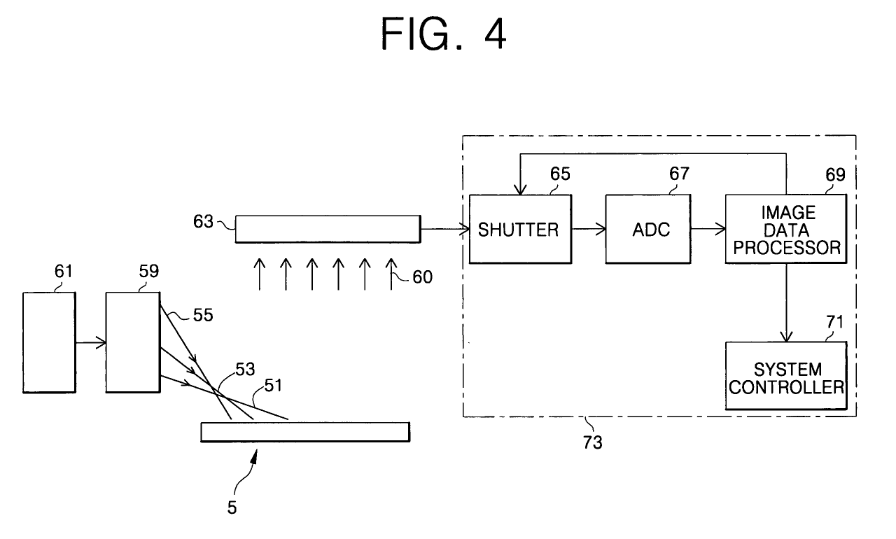

FIG. 4 is a schematic view illustrating a digital scanner that employs the optical image detector shown in FIG. 3.

Referring to FIG. 4, the digital scanner according to an embodiment of the present invention comprises the optical image detector shown in FIG. 3. The photocurrents or photo voltages outputted from the optical sensor 63 of the optical image detector are converted to digital image signals through a signal processing unit 73. The signal processing unit 73 comprises an analog-to-digital converter (A/D converter) 67 converting the photocurrents or photo voltages serially outputted from the pixels of the optical sensor 63 to digital signals and an image data processor 69 estimating amount of lights to the total image based on the digital signals from the A/D converter 67. The signals outputted from the image data processor 69 are transmitted to a system controller 71.

The signal processing unit 73 may further comprise an automatic shutter 65, which is electronically controlled and is installed between the A/D converter 67 and the optical sensor 63. The shutter 65 acts as a contrast controller that controls the total amount of optical signals such as the photocurrents or the photo voltages outputted from the optical sensor 63. The shutter 65 may be installed in the front of the optical sensor 63. In this case, the shutter 65 controls the total intensity of lights reflected from the surface of the object 5. The shutter 65 is controlled by the image data processor 69. Alternatively, the shutter 65 may be controlled by the system controller 71.

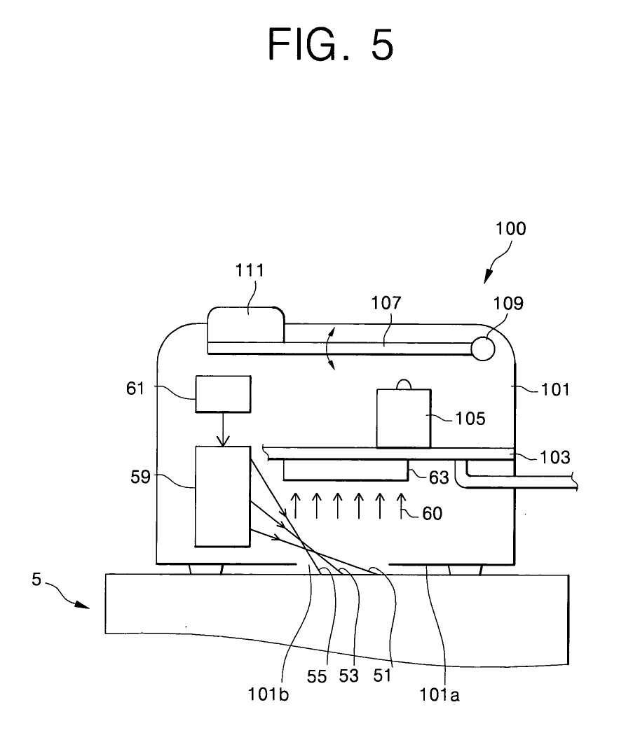

FIG. 5 is a schematic cross-sectional view illustrating an optical mouse that employs the optical image detector shown in FIG. 3.

Referring to FIG. 5, the optical mouse 100 is placed on the surface of the object 5 such as the worktable shown in the FIG. 1. The optical mouse 100 comprises a case 101 having a lower panel 101a. The lower panel 101a has an opening 101b that penetrates a predetermined region thereof. The light source 61, the incident light generator 59 and the optical sensor 63, which are shown in FIG. 3, are disposed in the case 101. Accordingly, the lights emitted from the light source 61 are converted to the first to third groups of incident lights 51, 53 and 55 through the incident light generator 59 as shown in FIG. 3, and the incident lights 51, 53 and 55 are illuminated on the surface of the object 5 through the opening 101b. The incident lights 51, 53 and 55 are reflected on the surface of the object 5, and the reflected lights 60 are illuminated toward the optical sensor 63, which is located over the opening 101b. The optical sensor 63 senses the reflected lights 60, thereby generating optical signals such as photocurrents or photo voltages that correspond to an image for the surface morphology of the object 5 under the opening 101b.

The optical sensor 63 is mounted on a printed circuit board 103, which is installed in the case 101. The circuit realized on the printed circuit board 103 processes in sequence the optical signals outputted from the optical sensor 63 to yields the total amount of the reflected lights 60. The amount of the reflected lights 60 is changed whenever the mouse is moved. This is because fine protrusions irregularly exist at the surface the object 5. Thus, the movement of the mouse can be traced using a change of the amount of the reflected lights.

A switch module 105 is mounted on a predetermined area of the printed circuit board 103. A horizontal bar 107 is disposed over the switch module 105, and one end of the horizontal bar 107 is connected to a hinge 109 that is fixed in the case 101. Also, a button 111 is attached on the other end of the horizontal bar 107 and the button 111 is upwardly protruded through a hole that penetrates a predetermined area of an upper panel of the case 101. The horizontal bar 107 is lifted up and separated from the switch module 105 by a resilient member (not shown) such as a spring. Accordingly, whenever the button 111 is pressed down, the switch module 105 is turned on. As a result, if the button 111 is clicked on, an operation that corresponds to a position indicated by the cursor is performed.

In the meantime, the incident light generator 59, which is shown in FIG. 3, can be applicable to a navigation device such as a pattern recognizer that recognizes a human fingerprint. In this case, the object 5 shown in FIGS. 4 and 5 may be a human finger.

According to the present invention, at least two groups of incident lights having different incident angles are illuminated on the surface of the object. Thus, it is possible to improve the resolution of an image for the surface morphology of the object.

What is claimed is:

1. An optical image detector that illuminates incident lights on a surface of an object to generate an image for surface morphology of the object, the optical image detector comprising:
a light source; and
an incident light generator receiving lights of the light source to generate at least two groups of incident lights having different incident angles with respect to the surface of the object.

2. The optical image detector according to claim 1, wherein the incident light generator comprising:
a first reflecting plate reflecting the lights of the light source to generate a first group of incident lights having a first incident angle with respect to the surface of the object;
a second reflecting plate reflecting the lights of the light source to generate a second group of incident lights having a second incident angle greater than the first incident angle with respect to the surface of the object; and
a third reflecting plate reflecting the lights of the light source to generate a third group of incident lights having a third incident angle greater than the second incident angle with respect to the surface of the object.

3. The optical image detector according to claim 1, further comprising an optical sensor that is disposed over the surface of the object to sense the lights reflected from the surface of the object, wherein the optical sensor converts an image for the surface morphology of the object into photocurrents.

4. A navigation device comprising:
a case including a lower panel having an opening;
a light source installed in the case; and
an incident light generator disposed to be adjacent to the light source and receiving lights of the light source to generate at least two groups of incident lights having different incident angles with respect to the surface of the object, wherein the incident lights being illuminated on the surface of the object through the opening.

5. The navigation device according to claim 4, wherein the light source is a light emitting device that generates infrared or visual spectrum rays.

6. The navigation device according to claim 4, wherein the at least two groups of incident lights comprising:
a first group of incident lights having a first incident angle with respect to the surface of the object;
a second group of incident lights having a second incident angle greater than the first incident angle with respect to the surface of the object; and
a third group of incident lights having a third incident angle greater than the second incident angle with respect to the surface of the object.

7. The navigation device according to claim 6, wherein the incident light generator comprising:
a first reflecting plate reflecting the lights of the light source to generate the first group of incident lights;
a second reflecting plate reflecting the lights of the light source to generate the second group of incident lights; and
a third reflecting plate reflecting the lights of the light source to generate the third group of incident lights.

8. The navigation device according to claim 4, further comprising an optical sensor that is disposed over the opening to sense the lights reflected from the surface of the object, wherein the optical sensor converts an image for the surface morphology of the object into photocurrents.
